(19) United States
(12) Patent Application Publication
(10) Pub. No.: US 2026/0079831 A1
(43) Pub. Date: Mar. 19, 2026

(54) MEMORY SYSTEM, INFORMATION PROCESSING SYSTEM, AND MEMORY SYSTEM CONTROL METHOD

(71) Applicant: Kioxia Corporation, Tokyo (JP)

(72) Inventors: Tomoya SUZUKI, Kamakura Kanagawa (JP); Kazuhiro HIWADA, Kamakura Kanagawa (JP)

(73) Assignee: Kioxia Corporation, Tokyo (JP)

(21) Appl. No.: 19/068,143

(22) Filed: Mar. 3, 2025

(30) Foreign Application Priority Data
Sep. 19, 2024 (JP) 2024-162316

(51) Int. Cl. G06F 12/02; G06F 12/12; G06F 13/16

(52) U.S. Cl. CPC G06F 12/0246; G06F 12/12; G06F 13/1626

(57) ABSTRACT

According to embodiments, a memory system includes a data management circuit, a memory, a write control circuit, and a data determination circuit. The data management circuit manages data, which is received from a host on a first data size basis, on a second data size basis. The second data size is greater than the first data size. The data determination circuit determines whether or not data of the second data size received by the write control circuit matches a data pattern set in advance. In a case where first data received by the write control circuit matches the data pattern, the data management circuit sets a flag indicating that the first data matches the data pattern in an entry of a management table corresponding to the first data, and the write control circuit discards the first data without writing the first data to the memory.

### CROSS-REFERENCE TO RELATED APPLICATION

This application is based upon and claims the benefit of priority from Japanese Patent Application No. 2024-162316, filed Sep. 19, 2024, the entire contents of which are incorporated herein by reference.

### FIELD

Embodiments described herein relate generally to a memory system, an information processing system, and a memory system control method.

### BACKGROUND

There is a compute express link (CXL™) as one of interconnect standards between a host and a memory system. The CXL uses a signal that is physically the same as a signal of peripheral component interconnect-express (PCIe™). The CXL includes three protocols that are (CXL.io), (CXL.mem), and (CXL.cache). The CXL.io is a PCIe-based protocol. The CXL.mem is a protocol for coherently accessing a memory device included in a memory system. The CXL.cache is a protocol for allowing a peripheral device to access a host while maintaining cache coherency.

### BRIEF DESCRIPTION OF DRAWINGS

FIG. 1 is a block diagram illustrating an example of an overall configuration of an information processing system according to a first embodiment.

FIG. 2 is a block diagram illustrating an example of a data structure of a page included in the memory system according to the first embodiment.

FIG. 3 is a diagram illustrating a specific example of an L2P table included in the memory system according to the first embodiment.

FIG. 4 is a block diagram illustrating an example of a functional configuration focusing on a flow of data in the memory system according to the first embodiment.

FIG. 5 is a block diagram illustrating an example of a configuration of a cache included in the memory system according to the first embodiment.

FIG. 6 is a flowchart illustrating an example of an overall flow in a case where a write request of SEG data of all “0” is issued from a host to the memory system in the information processing system according to the first embodiment.

FIG. 7 is a flowchart illustrating an example of a flow of a read-modify-write operation in the memory system according to the first embodiment.

FIG. 8 is a flowchart illustrating an example of a flow of a refill operation with respect to a read request in the memory system according to the first embodiment.

FIG. 9 is a block diagram illustrating an example of a functional configuration of the memory system focusing on a flow of data according to a second embodiment.

FIG. 10 is a flowchart illustrating an example of an overall flow in a case of issuing a trim request from a host to the memory system in an information processing system according to the second embodiment.

FIG. 11 is a flowchart illustrating an example of a flow of trim processing in the memory system according to the second embodiment.

FIG. 12 is a flowchart illustrating an example of a flow of trim processing in a memory system according to a modification of the second embodiment.

FIG. 13 is a diagram illustrating a specific example of an L2P table included in a memory system according to a third embodiment.

FIG. 14 is a flowchart illustrating an example of a flow of a read-modify-write operation in the memory system according to the third embodiment.

FIG. 15 is a flowchart illustrating an example of a flow of a refill operation with respect to a read request in the memory system according to the third embodiment.

FIG. 16 is a block diagram illustrating an example of functional configurations of a host and a memory system focusing on a flow of data in an information processing system according to a fourth embodiment.

### DETAILED DESCRIPTION

In general, according to one embodiment, a memory system includes a data management circuit, a memory configured to store data, a write control circuit configured to control writing of data to the memory, and a data determination circuit. The data management circuit is configured to manage data, which is received from a host on a first data size basis, on a second data size basis by using a management table. The second data size is greater than the first data size. The data determination circuit is configured to determine whether or not data of the second data size received by the write control circuit matches a data pattern set in advance. In a case where first data of the second data size received by the write control circuit matches the data pattern, the data management circuit is further configured to set a flag indicating that the first data matches the data pattern in an entry of the management table corresponding to the first data, and the write control circuit is further configured to discard the first data without writing the first data to the memory.

Embodiments will be described below with reference to the drawings. In the following description, components having the same function and configuration are denoted by the same reference signs. In addition, in a case where a plurality of components having a common reference sign is distinguished, the common reference sign is added with an index for distinction. Note that, in a case where a plurality of components does not need to be particularly distinguished, only the common reference signs are attached to the plurality of components without an index. Here, the index is not limited to a subscript or a superscript, and includes, for example, a lowercase alphabet character added to the end of the reference sign, an index meaning an array, and the like.

### 1. First Embodiment

A memory system according to an embodiment will be described below.

### 1.1 Configuration

### 1.1.1 Configuration of Information Processing System

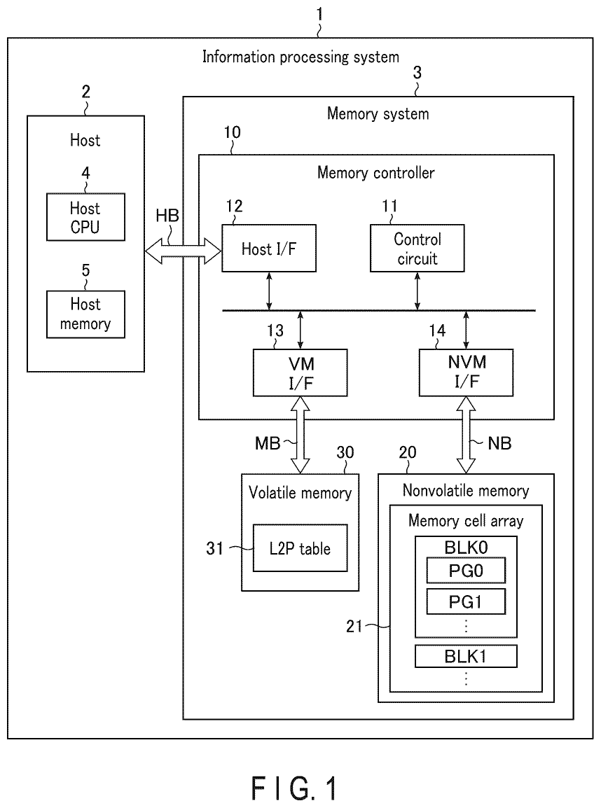

First, an example of a configuration of an information processing system 1 will be described with reference to FIG. 1. FIG. 1 is a block diagram illustrating an example of the overall configuration of the information processing system 1.

As illustrated in FIG. 1, the information processing system 1 includes a host 2 and a memory system 3. Note that a plurality of hosts 2 may be coupled to the memory system 3, or a plurality of memory systems 3 may be coupled to the host 2. For example, the memory system 3 is coupled to the host 2 via a host bus HB. Note that the memory system 3 may be coupled to the host 2 via a network or wireless communication. The present embodiment will describe a case where CXL™ is applied as an interconnect standard of the host bus HB. Note that the interconnect standard is not limited to CXL™.

The host 2 is an information processing apparatus that accesses the memory system 3. The host 2 controls the memory system 3. More specifically, for example, the host 2 issues a request (instruction) to write or read data to the memory system 3. That is, the host 2 transmits a write request or a read request to the memory system 3. For example, the write request includes data, a command, and a host physical address. The read request includes a command and a host physical address. The host physical address is an address used by the host 2. For example, the host 2 transmits and receives data with the memory system 3 based on the CXL.mem protocol.

The memory system 3 is, for example, a Type 3 device in CXL™. The memory system 3 may be a solid state drive (SSD). The memory system 3 executes various operations based on an access request from the host 2. When the operation based on the access request (command) is completed, the memory system 3 transmits a command response to the host 2.

### 1.1.2 Internal Configuration of Host

Subsequently, an example of the internal configuration of the host 2 will be described with reference to FIG. 1. The host 2 includes a host central processing unit (CPU) 4 and a host memory 5. The host CPU 4 and the host memory 5 are coupled to each other by, for example, an internal bus of the host 2.

The host CPU 4 controls the entire information processing system 1. More specifically, the host CPU 4 controls, for example, the issuance of a write request and a read request to the memory system 3, that is, input and output of data to and from the memory system 3. For example, the host CPU 4 has a virtual memory function. A memory management unit of the host CPU 4 converts a virtual memory address into a host physical address. The host CPU 4 accesses the host memory 5 and the memory system 3 using the host physical address.

The software executed on the host CPU 4 in the present embodiment transmits a write request to the memory system 3 so as to write all “0” into the corresponding memory space of the memory system 3 upon a call, such as free( ), for releasing the memory space that is being used. The timing at which the memory space is released is not limited to the calling of free( ).

The host memory 5 is, for example, a volatile memory. The host memory 5 may be a dynamic random access memory (DRAM) or a static random access memory (SRAM). The host memory 5 can be used as a work area when the host CPU 4 executes an OS, an application program, etc. In the present embodiment, a case where the host memory 5 is provided in the host 2 will be described, but the present invention is not limited thereto. For example, the host memory 5 may be coupled to the host bus HB as a standalone memory device.

### 1.1.3 Configuration of Memory System

Next, an example of the configuration of the memory system 3 will be described with reference to FIG. 1. The memory system 3 includes a memory controller 10, a nonvolatile memory 20, and a volatile memory 30.

The memory controller 10 includes, for example, an integrated circuit such as a system-on-a-chip (SoC). The memory controller 10 may include a plurality of semiconductor chips. The memory controller 10 controls the nonvolatile memory 20 and the volatile memory 30 based on a request from the host 2.

The nonvolatile memory 20 is a nonvolatile storage medium. The nonvolatile memory 20 is coupled to the memory controller 10 via, for example, a NAND bus NB. The nonvolatile memory 20 stores the data received from the memory controller 10 in a nonvolatile manner. The nonvolatile memory 20 functions as a data storage unit in the memory system 3. In the following, a case where the nonvolatile memory 20 is a NAND flash memory will be described. The nonvolatile memory 20 may include a plurality of memory chips. In this case, the plurality of memory chips can operate independently.

The nonvolatile memory 20 includes at least one memory cell array 21. The memory cell array 21 is a set of a plurality of memory cells arranged in a matrix. The memory cell stores data in a nonvolatile manner. That is, the memory cell array 21 is a physical memory area that stores data in a nonvolatile manner.

The memory cell array 21 includes a plurality of blocks BLK (BLK0, BLK1, . . . ). The block BLK is, for example, a set of a plurality of memory cells that collectively have their data erased. That is, the block BLK is a unit of erasure of data. In addition, the block BLK includes a plurality of pages PG. The page PG is a unit of data that is collectively written to (or collectively read from) the memory cell array 21. The nonvolatile memory 20 can simultaneously execute the write operations or the read operations on a plurality of pages PG. When changing data already written in the nonvolatile memory 20, new data is written to a different (erased) page PG, rather than overwriting the existing data.

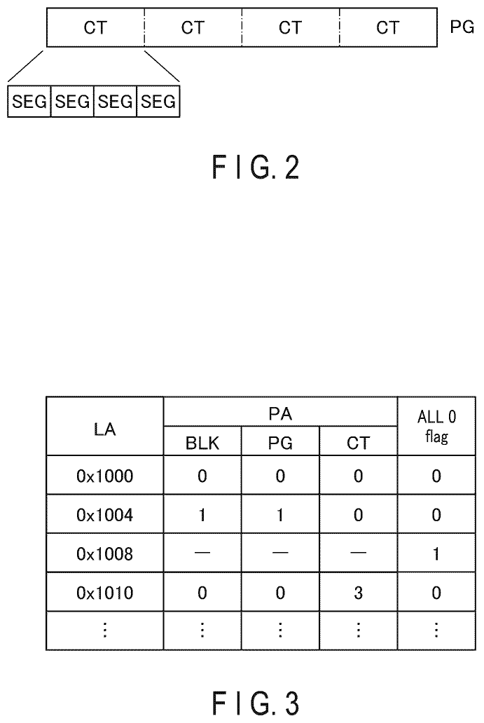

An example of the data structure of the page PG will be described with reference to FIG. 2. FIG. 2 is a block diagram illustrating an example of a data structure of the page PG.

As illustrated in FIG. 2, the page PG includes a plurality of clusters CT. In the example illustrated in FIG. 2, the page PG includes four clusters CT. The cluster CT is a unit of management of data in the memory controller 10. For example, the memory controller 10 can execute data encoding and error correction for each cluster CT. The nonvolatile memory 20 can transmit only data of some clusters CT of the page PG that has been read to the memory controller 10.

In addition, each cluster CT includes a plurality of segments SEG. In the example illustrated in FIG. 2, each cluster CT includes four segments SEG. The segment SEG is a unit of data transmitted and received between the host 2 and the memory system 3. Therefore, the granularity of data accessed between the host 2 and the memory system 3 is finer than the unit of management of data in the memory system 3. In a case where the memory system 3 is an SSD, the memory system 3 is configured to transmit and receive, for example, data of 512 bytes at minimum between the host 2 and the memory system 3. In a case where the memory system 3 is a Type 3 device in CXL™, the memory system 3 is configured to transmit and receive, for example, data of 64 bytes at minimum between the host 2 and the memory system 3. In the following description, the data of the segment SEG is referred to as “SEG data”. The data of the cluster CT is referred to as “CT data”. The data of the page PG is referred to as “PG data”.

In addition, the memory cell array 21 stores an L2P table (also referred to as a “logical-to-physical conversion table” or a “look-up table”) in a nonvolatile manner. The L2P table is a table indicating a relationship between a logical address and a physical address corresponding thereto. In other words, the L2P table is metadata for managing data accessed from the host 2. The logical address is an address used by the host 2 to access the memory system 3. The physical address is an address for specifying a physical memory position in a memory area of the nonvolatile memory 20 (memory cell array 21). In the present embodiment, a host physical address output from the host 2 is used as a logical address for accessing the memory system 3. In other words, the L2P table is a table indicating a relationship between the host physical address received from the host 2 and the physical address of the nonvolatile memory 20.

Returning to FIG. 1, the volatile memory 30 is a volatile storage medium. The volatile memory 30 is coupled to the memory controller 10 via, for example, a memory bus MB. The volatile memory 30 is, for example, a DRAM. The volatile memory 30 is used as, for example, a cache or a write buffer that temporarily stores data. In addition, the volatile memory 30 stores the L2P table 31 loaded from the nonvolatile memory 20 by the memory controller 10. The memory controller 10 manages mapping between the logical address and the physical address using the L2P table 31 loaded into the volatile memory 30. For example, the L2P table 31 is updated when the write operation is executed in the nonvolatile memory 20. For example, the memory controller 10 updates the L2P table stored in the nonvolatile memory 20 at any timing based on the L2P table 31 of the volatile memory 30. The L2P table 31 includes a plurality of entries. Each of the entries includes a logical address LA and a physical address PA corresponding to the logical address LA. In a case where the memory system 3 is a Type 3 device in CXL™, the L2P table 31 is managed, for example, in a unit of 256 bytes made up of four consecutive data by address for data of 64 bytes indicating the granularity of data accessed between the host 2 and the memory system 3.

An example of the L2P table 31 will be described with reference to FIG. 3. FIG. 3 is a diagram illustrating a specific example of the L2P table 31.

As illustrated in FIG. 3, the L2P table 31 includes information regarding the logical address LA, information regarding the physical address PA, and information regarding an ALL0 flag for each entry. In the L2P table 31, an entry is provided for each cluster CT. The example illustrated in FIG. 3 illustrates a case where four pieces of SEG data corresponding to four consecutive logical addresses LA are stored in one cluster CT. As the information regarding the logical address LA, for example, information regarding the head address of four consecutive logical addresses LA is stored. Note that, in the L2P table 31, the logical addresses LA field may be omitted by using an index number of the entry instead of the logical address LA. As the information regarding the physical address PA, for example, information regarding the block BLK, the page PG, and the cluster CT is stored.

The ALL0 flag is information indicating whether or not data in the cluster CT is all “0”. For example, in a case where “1” data is included in the cluster CT, that is, in a case where CT data is not all “0”, the ALL0 flag is set to “0”. On the other hand, in a case where all pieces of data in the cluster CT are “0” data, that is, in a case where CT data is all “0”, the ALL0 flag is set to “1” (also referred to as “set up the ALL0 flag”). In a case where the ALL0 flag is “1”, the physical address PA corresponding to the logical address LA may not be assigned. That is, in a case where the ALL0 flag is set, the write operation to the nonvolatile memory 20 is unnecessary. Note that all “0” may be written in the nonvolatile memory 20. When receiving the read request, the memory controller 10 checks the L2P table 31. In a case where the ALL0 flag is “1”, the memory controller 10 finds that the corresponding CT data is all “0”. In this case, the memory controller 10 can omit the read operation in the nonvolatile memory 20.

Note that the ALL0 flag may not be provided in the L2P table 31. For example, instead of the ALL0 flag, a physically unused physical address PA (dummy address) may be set. For example, in a case where CT data is all “0”, a dummy address is assigned to the physical address PA. In a case where the dummy address is assigned to the physical address PA, the memory controller 10 finds that the corresponding CT data is all “0”.

For example, in a case where the ALL0 flag is changed from “0” to “1” by data rewriting, the physical address PA corresponding to the logical address LA of the entry, that is, the memory area of the nonvolatile memory 20, is in a released state. That is, data in the memory area is regarded as invalid data. The invalid data is data unassociated with the logical address LA.

In the example illustrated in FIG. 3, the cluster CT0 of the page PG0 of the block BLK0 is assigned to “0x1000” of the logical address LA, and the ALL0 flag is set to “0”. The cluster CT0 of the page PG1 of the block BLK1 is assigned to “0x1004” of the logical address LA, and the ALL0 flag is set to “0”. The ALL0 flag corresponding to “0x1008” of the logical address LA is set to “1”, and the physical address PA is not assigned. The cluster CT3 of the page PG0 of the block BLK0 is assigned to “0x1010” of the logical address LA, and the ALL0 flag is set to “0”.

### 1.1.4 Hardware Configuration of Memory Controller

Next, an example of the hardware configuration of the memory controller 10 will be described with reference to FIG. 1.

The memory controller 10 includes a control circuit 11, a host interface circuit (host I/F) 12, a volatile memory interface circuit (VM I/F) 13, and a nonvolatile memory interface circuit (NVM I/F) 14. The functions of the control circuit 11, the host interface circuit 12, the volatile memory interface circuit 13, and the nonvolatile memory interface circuit 14 described below can be implemented by any of dedicated hardware, a processor that executes a program, and a combination thereof.

The control circuit 11 is a circuit that controls the entire memory controller 10. The control circuit 11 includes, for example, a processor such as a CPU, a read only memory (ROM), and a random access memory (RAM). For example, the control circuit 11 instructs the nonvolatile memory 20 to perform various operations based on a request (a write request, a read request, etc.) from the host 2.

Specifically, for example, in a case where the write request from the host 2 is a change of data in some logical address LA that is already written in nonvolatile memory 20, the control circuit 11 executes the read-modify-write operation. The read-modify-write operation is an operation of modifying data read from the nonvolatile memory 20 and writing the data back to the nonvolatile memory 20. SEG data received by the memory controller 10 is smaller than the unit of management of the memory controller 10. Therefore, when receiving the write request, the control circuit 11 reads data of the address range including the logical address LA in the write request, that is, CT data, from the nonvolatile memory 20. Note that the address range in this case corresponds to one entry of the L2P table 31. Then, the control circuit 11 modifies data of the corresponding segment SEG in the read CT data and (eventually) writes the modified CT data back to the nonvolatile memory 20.

In addition, the control circuit 11 executes various processes for managing the nonvolatile memory 20, such as garbage collection. The garbage collection is also referred to as compaction. The garbage collection is a process of reading (collecting) valid data from the blocks BLK of the nonvolatile memory 20 and rewriting (copying) the valid data into another block BLK. The valid data is, for example, data associated with a logical address. The block BLK in which all the valid data has been copied by the garbage collection is in an erasable state. When changing data already written in the nonvolatile memory 20, new data is written to a different (erased) page PG, rather than overwriting the existing data. Therefore, as the data changing progresses, the invalid data increases in the block BLK. However, if at least one piece of valid data remains in the block, the erase operation of the block BLK cannot be executed. For example, in a case where the number of erasable blocks BLK decreases, garbage collection is executed to increase the number of erasable blocks.

The host interface circuit 12 manages communication between the memory controller 10 and the host 2. The host interface circuit 12 is coupled to the host 2 via the host bus HB. The host bus HB conforms to, for example, CXL™. The host bus HB may conform to another standard such as non-volatile memory express (NVMe™).

The volatile memory interface circuit 13 manages communication between the memory controller 10 and the volatile memory 30. The memory bus MB that couples the volatile memory 30 and the memory controller 10 conforms to, for example, the DRAM interface standard.

The nonvolatile memory interface circuit 14 manages communication between the memory controller 10 and the nonvolatile memory 20. The nonvolatile memory interface circuit 14 is coupled to the nonvolatile memory 20 via the NAND bus NB. The NAND bus NB conforms to, for example, a single data rate (SDR) interface, a toggle double data rate (DDR) interface, or an open NAND flash interface (ONFI).

### 1.1.5 Functional Configuration of Memory System

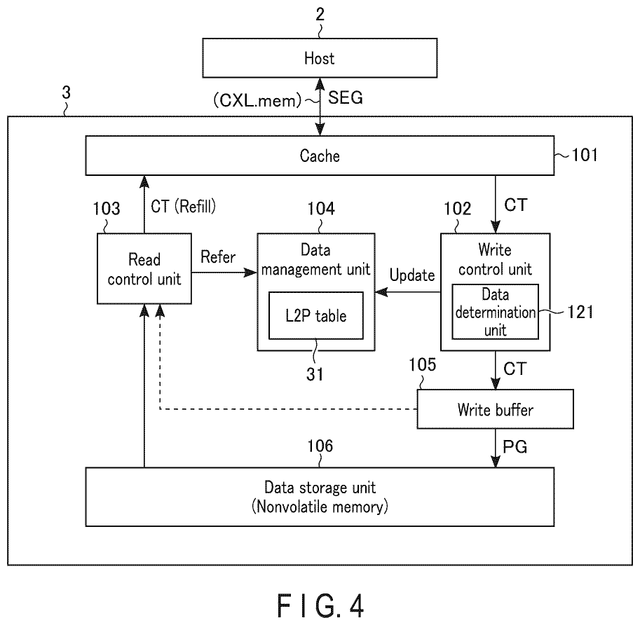

Next, an example of the functional configuration of the memory system 3 will be described with reference to FIG. 4. FIG. 4 is a block diagram illustrating an example of a functional configuration of the memory system 3 focusing on a flow of data.

As illustrated in FIG. 4, the memory system 3 includes a cache 101, a write control unit (circuit) 102, a read control unit (circuit) 103, a data management unit (circuit) 104, a write buffer 105, and a data storage unit 106 as functional configurations. For example, the functions of the write control unit 102, the read control unit 103, and the data management unit 104 are implemented by the control circuit 11.

The cache 101 temporarily stores data. The data memory area of the cache 101 is provided on the volatile memory 30. The cache 101 stores data which is read from the memory system 3 to the host2 via the CXL.mem and data which is written from the host 2 to the memory system 3 via the CXL.mem. Data having a high access frequency may be temporarily stored in the cache 101. The cache 101 stores SEG data received from the host 2 and CT data (also referred to as “refill data”) read from the data storage unit 106 (nonvolatile memory 20). The cache 101 has a plurality of cache lines. The cache line is, for example, a memory area for storing CT data.

The memory capacity of the cache 101 has an upper limit. Therefore, if there is no unused cache line, data in one of the cache lines is to be evicted. Hereinafter, the operation of evicting data from the cache 101 is referred to as “eviction operation”. For example, a cache line having a low access frequency, a cache line having the longest elapsed time from the last use, or the like is selected as the cache line from which data is to be evicted. CT data (also referred to as “write-back data”) evicted from the cache 101 is transmitted to the write control unit 102.

The write control unit 102 is a circuit that is configured to control a write operation (write-back operation) to the data storage unit 106. Hereinafter, an operation of writing the write-back data stored in the write buffer 105 to the data storage unit 106 is referred to as a write-back operation.

The write control unit 102 includes a data determination unit 121. The data determination unit 121 is a circuit that determines whether or not the write-back data (CT data) received from the cache 101 is all “0”. That is, the data determination unit 121 is a circuit that determines whether or not the write-back data (CT data) received from the cache 101 has a pattern matching a preset data pattern (in this case, all “0”).

In a case where the write-back data is all “0” (the write-back data has a pattern matching the preset data pattern) as a result of the determination by the data determination unit 121, the write control unit 102 gives a notification indicating that the write-back data is all “0” to the data management unit 104. The data management unit 104 sets the ALL0 flag of the entry corresponding to the write-back data to “1” in the L2P table 31. Then, the write control unit 102 discards CT data (all “0”) received from the cache 101 without executing the write-back operation to the data storage unit 106.

In addition, in a case where the write-back data (CT data) is not all “0” (the write-back data does not have a pattern matching the preset data pattern), the write control unit 102 executes the write-back operation. The write control unit 102 accesses the data management unit 104 during the write-back operation. The data management unit 104 updates the L2P table 31 and assigns a physical address PA to which the write-back data is written.

The read control unit 103 is a circuit that is configured to control the refill operation. The refill operation is an operation of reading an address range including the target logical address LA, that is, CT data (refill data) of the corresponding entry of the L2P table 31, from the data storage unit 106 (or the write buffer 105) and transmitting it to the cache 101, in a case where SEG data of the logical address LA designated by the write request or the read request is not stored in the cache 101. That is, the refill operation is an operation of replenishing (or filling) the cache line with data. For example, in a case where there is no unused cache line in the cache 101 at the time of the refill operation, a certain cache line is selected as a target from which data is to be evicted.

During the refill operation, the read control unit 103 accesses the data management unit 104 and refers to the L2P table 31. For example, in a case where the ALL0 flag of the entry corresponding to the refill data is set to “1”, the read control unit 103 generates all “0” and transmits it to the cache 101 without executing the read operation for the data storage unit 106 (or the write buffer 105).

The data management unit 104 is a circuit that is configured to manage the L2P table. That is, the data management unit 104 manages data stored in the memory system 3.

The write buffer 105 temporarily stores data to be written to the data storage unit 106. The data memory area of the write buffer 105 is provided on the volatile memory 30. The write buffer 105 may have a plurality of memory areas of a page size. For example, the memory capacity (the number of memory areas) of the write buffer 105 can be set based on the number of pages that can be collectively written. The write buffer 105 transmits PG data to the nonvolatile memory 20.

The data storage unit 106 is a memory that configured to store data in a nonvolatile manner. The data memory area of the data storage unit 106 is provided on the nonvolatile memory 20.

### 1.1.6 Cache Configuration

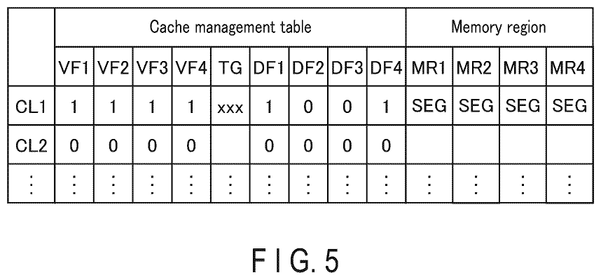

Next, an example of the configuration of the cache 101 will be described with reference to FIG. 5. FIG. 5 is a block diagram illustrating an example of the configuration of the cache 101.

As illustrated in FIG. 5, the cache 101 includes a plurality of cache lines CL (CL1, CL2, . . . ). Each of the cache lines CL has, for example, a memory capacity corresponding to one cluster CT. Each of the cache lines CL includes a plurality of memory areas for storing data and a cache management table for managing data stored in the cache line CL.

The memory region MR temporarily stores data. One memory region MR corresponds to one piece of SEG data. In the example illustrated in FIG. 5, each of the cache lines CL has four memory regions MR1 to MR4 corresponding to four pieces of SEG data included in one piece of CT data.

The cache management table includes four valid flags VF (VF1 to VF4), a tag TG, and four dirty flags DF (DF1 to DF4).

The valid flags VF1 to VF4 correspond to the four memory regions MR1 to MR4, respectively. The valid flag VF is a flag indicating whether or not SEG data stored in the corresponding memory region MR is valid data. For example, in a case where the corresponding memory region MR stores valid SEG data (valid data), the valid flag VF is set to “1”. On the other hand, in a case where the corresponding memory region MR does not store valid SEG data, the valid flag VF is set to “0”.

The tag TG is information that can specify the logical address LA corresponding to data stored in the cache line CL.

The dirty flags DF1 to DF4 correspond to the four memory regions MR1 to MR4, respectively. The dirty flag DF is a flag indicating whether or not SEG data stored in the corresponding memory region MR is dirty data that has received from the host 2 and has not been written to the data storage unit 106. For example, in a case where the corresponding memory region MR stores SEG data received from the host 2, the dirty flag DF is set to “1”. On the other hand, in a case where the corresponding memory region MR stores SEG data included in the refill data (CT data), the dirty flag DF is set to “0”. For example, in a case where at least one of the dirty flags DF1 to DF4 of the cache line CL from which data is to be evicted is set to “1”, data in the cache line CL is transmitted to the write control unit 102 as the write-back data. On the other hand, in a case where the dirty flags DF1 to DF4 of the cache line CL from which data is to be evicted are set to all “0”, the cache line CL is clean. Therefore, data in the cache line CL is discarded and is not transmitted to the write control unit 102. Note that, in a case where data in the cache line CL is held even after the write-back operation, the dirty flags DF1 to DF4 are each set to “0” after data is transferred to the write control unit 102.

In the example illustrated in FIG. 5, valid SEG data is stored in each of the memory regions MR1 to MR4 of the cache line CL1. In this case, the valid flags VF1 to VF4 are set to “1”. The dirty flags DF1 and DF4 are set to “1”, and the dirty flags DF2 and DF3 are set to “0”. In this case, SEG data received from the host 2 is stored in the memory regions MR1 and MR4, and SEG data included in the refill data is stored in the memory regions MR2 and MR3. Valid SEG data is not stored in the memory regions MR1 to MR4 of the cache line CL2. That is, the cache line CL2 is an unused cache line. In this case, the valid flags VF1 to VF4 and the dirty flags DF1 and DF4 are set to “0”.

### 1.2 Overall Flow of Write Request of All “0”

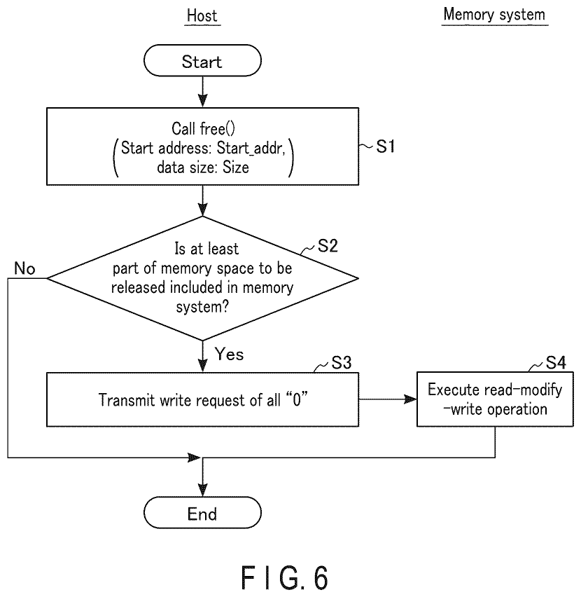

Next, an example of an overall flow in a case where a write request of SEG data of all “0” is issued from the host 2 to the memory system 3 will be described with reference to FIG. 6. FIG. 6 is a flowchart illustrating an example of an overall flow in a case where a write request of SEG data of all “0” is issued from the host 2 to the memory system 3. The example illustrated in FIG. 6 illustrates a case where the host 2 requests writing of SEG data of all “0” based on free( ). The free( ) is a function giving an instruction on release of the memory space. Note that the function giving the instruction on release of the memory is not limit to the free( ). In the present embodiment, the host 2 issues a write request of SEG data of all “0” to the corresponding memory space in response to the call by the free( ). Note that the write request of SEG data of all “0” is not limited to releasing memory space. However, the write data may simply be valid data of all “0”. Note that all “0” has nothing to do with the release of the memory in that case. The write request of SEG data of all “0” may include a case based on free( ) and a case based on a normal write operation.

As illustrated in FIG. 6, the host 2 calls free( ) (S1). The memory space to be released by free( ) is expressed by a start address Start_addr and a data size Size. The start address Start_addr is, for example, a virtual memory address. Any size is used as the data size Size. For example, in a case where the memory space to be released is in the memory system 3, data unit of the data size Size is the same as that of the segment SEG. In this case, the data size Size may be a data size corresponding to a plurality of segments SEG.

When calling free( ), the host CPU 4 of the host 2 checks whether or not at least a part of the memory space to be released is included in the memory system 3. For example, there is a case where the memory space of the memory system 3 and the memory space of the host memory 5 are mixed in the memory space corresponding to the data size Size from the start address Start_addr on the virtual memory address. In this case, a part of the memory space to be released is included in the memory space of the memory system 3. In a case where at least a part of the memory space to be released is not included in the memory system 3 (S2_No), the host CPU 4 does not issue a write request to the memory system 3. For example, in a case where the memory space to be released are all included in the host memory 5, the host CPU 4 releases the target memory space of the host memory 5 and ends the operation corresponding to free( ).

In a case where at least a part of the memory space to be released is included in the memory system 3 (S2_Yes), the host CPU 4 transmits a write request of all “0” to the memory system 3 (S3). More specifically, the host CPU 4 converts the virtual memory address corresponding to the memory system 3 into the host physical address (logical address LA). The host CPU 4 transmits a write request including the converted host physical address and all “0” to the memory system 3. For example, in a case where a plurality of segments SEG is included in a memory space to be released in the memory system 3, the host CPU 4 transmits a plurality of write requests to the memory system 3.

The memory system 3 executes the read-modify-write operation based on the received write request (S4). When completing the read-modify-write operation, the memory system 3 transmits a command response to the host 2.

### 1.3 Read-Modify-Write Operation in Memory System

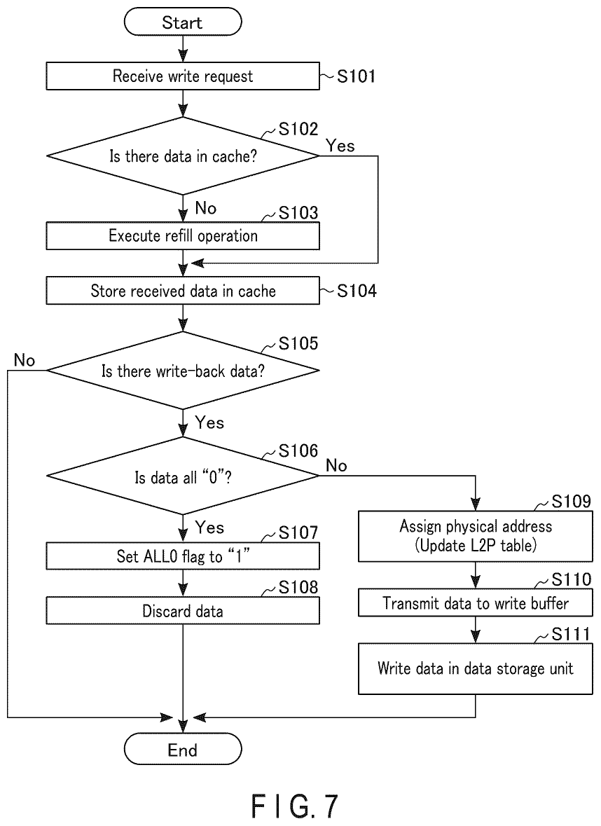

Next, an example of a flow of the read-modify-write operation in the memory system 3 will be described with reference to FIG. 7. FIG. 7 is a flowchart illustrating an example of a flow of the read-modify-write operation in the memory system 3. The following description will focus on a case where the data received from the host 2 is SEG data of all “0”.

As illustrated in FIG. 7, the memory system 3 receives a write request from the host 2 (S101). For example, the memory system 3 receives SEG data of all “0” from the host 2 as write data.

The cache 101 is checked whether or not there is data corresponding to the logical address LA of the write request in any of the cache lines CL.

In a case where there is the corresponding data in the cache 101 (S102_Yes), the refill operation is not executed.

In a case where there is no corresponding data in the cache 101 (S102_No), the read control unit 103 refers to the L2P table 31 and executes the refill operation (S103). More specifically, the read control unit 103 refers to the L2P table. In a case where the ALL0 flag of the corresponding entry is “0”, the read control unit 103 reads data from the write buffer 105 or the data storage unit 106 (nonvolatile memory 20) and transmits the read data to the cache 101. On the other hand, in a case where the ALL0 flag of the corresponding entry is “1”, the read control unit 103 generates refill data of all “0” and transmits the refill data to the cache 101. Note that, in a case where there is no unused cache line CL at the time of the refill operation, one of cache lines CL is selected as a target from which data is to be evicted. In a case where the dirty flags DF1 to DF4 of the cache line CL from which data is to be evicted are all “0”, that is, in a case where the cache line CL is clean, the data stored in the cache line CL is discarded. On the other hand, in a case where at least one of the dirty flags DF1 to DF4 of the cache line CL from which data is to be evicted is “1”, the data stored in the cache line CL is transmitted to the write control unit 102. That is, the write-back data is transmitted to the write control unit 102.

SEG data received from the host 2 is stored in the cache 101 (S104). For example, in the case of rewriting to SEG data of all “0”, SEG data of the corresponding memory region MR of the cache line CL is rewritten to all “0”.

In a case where there is no write-back data (S105_No), the write control unit 102 ends the read-modify-write operation.

In a case where there is write-back data (S105_Yes), the data determination unit 121 of the write control unit 102 checks whether or not the write-back data is all “0”.

In a case where the write-back data is all “0” (S106_Yes), the data management unit 104 sets the ALL0 flag of the corresponding entry of the L2P table 31 to “1” (S107). Then, the write control unit 102 discards the write-back data without executing the write-back operation (S108). For example, in a case where the ALL0 flag is changed from “0” to “1”, the memory area of the physical address PA associated with the logical address LA of the corresponding entry is released. In other words, in the data storage unit 106, data stored in the memory area corresponding to the physical address PA is set as invalid data.

In a case where the write-back data is not all “0” (S106_No), the data management unit 104 sets the ALL0 flag of the corresponding entry of the L2P table 31 to “0” and assigns one of the physical addresses PA (S109). That is, the L2P table is updated. Then, the write control unit 102 transmits the write-back data to the write buffer 105 (S110).

When the amount of data stored in the write buffer 105 reaches the amount of data to be used for the write-back operation, PG data is transmitted from the write buffer 105 to the data storage unit 106, and the write-back operation is executed in the data storage unit 106 (S111).

### 1.4 Refill Operation

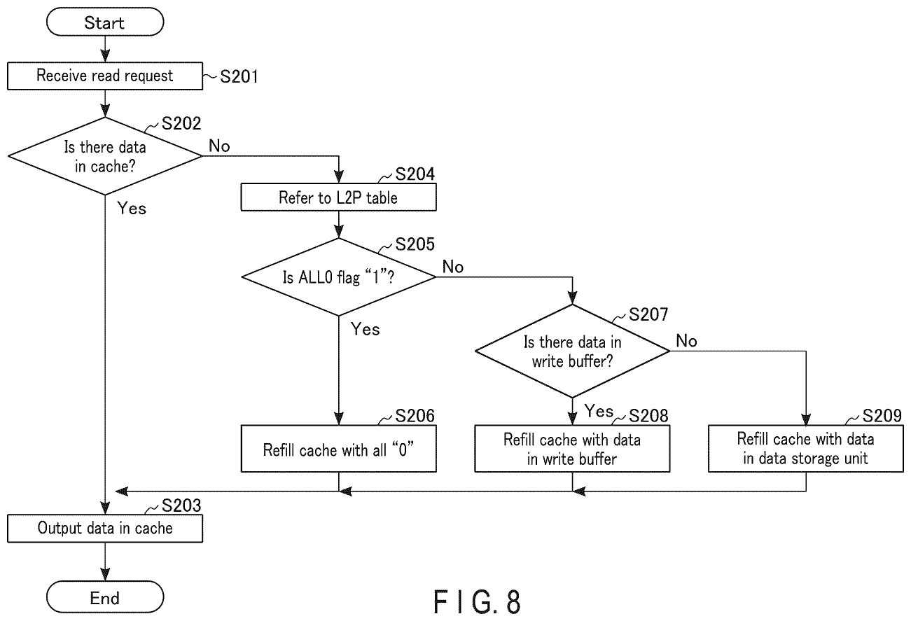

Next, an example of a flow of the refill operation will be described with reference to FIG. 8. FIG. 8 is a flowchart illustrating an example of a flow of the refill operation. FIG. 8 illustrates a case where the refill operation is executed based on the read request. Note that the same applies to the refill operation in the read-modify-write operation.

As illustrated in FIG. 8, the memory system 3 receives a read request from the host 2 (S201).

The cache 101 is checked whether or not data corresponding to the logical address LA of the read request is included in any of the cache lines CL.

In a case where there is the corresponding data in the cache 101 (S202_Yes), the refill operation is not executed.

In a case where there is no corresponding data in the cache 101 (S202_No), the read control unit 103 refers to the L2P table 31 (S204).

In a case where the ALL0 flag of the entry corresponding to the address range including the logical address LA of the read request is “1” (S205_Yes), the read control unit 103 generates refill data of all “0” and refills the cache 101 with the refill data (S206).

In a case where the ALL0 flag of the entry corresponding to the address range including the logical address LA of the read request is “0” (S205_No), the read control unit 103 checks whether or not data corresponding to the logical address LA of the read request is included in the write buffer 105.

In a case where there is the corresponding data in the write buffer 105 (S207_Yes), the read control unit 103 refills the cache 101 with the data (CT data) of the write buffer 105 as refill data (S208).

In a case where there is no corresponding data in the write buffer 105 (S207_No), the read control unit 103 executes a read operation in the data storage unit 106 (nonvolatile memory 20). The cache 101 is refilled with the data (CT data) read from the data storage unit 106 as refill data (S209).

In a case where there is the corresponding data in the cache 101 (S202_Yes), or after the cache 101 is refilled with the data by any of steps S206, S208, and S209, the read control unit 103 outputs SEG data corresponding to the logical address LA of the read request in the cache 101 to the host (S203).

### 1.5 Effects According to Present Embodiment

For example, the granularity of data accessed between the host 2 and the memory system 3 may be finer than the unit of management of data in the memory system 3. In this case, the memory system 3 releases the memory area in the unit of management of data.

On the other hand, with the configuration according to the present embodiment, when releasing the memory space of the memory system 3, the host 2 can transmit a write request of SEG data of all “0” to the memory system 3. The memory system 3 can replace SEG data in the memory area to be released with SEG data of all “0” by the read-modify-write operation. Therefore, the memory system 3 can be notified to release the memory area with finer granularity than the unit of management of data.

Furthermore, in the configuration according to the present embodiment, the memory system 3 includes the data determination unit 121 and the data management unit 104. The data determination unit 121 can determine whether or not the write-back data (CT data) is all “0”. The data management unit 104 can set an ALL0 flag indicating that CT data corresponding to the entry is all “0” in the L2P table 31. The data management unit 104 can set up the ALL0 flag of the L2P table 31. Further, the data management unit 104 can omit assignment of the physical address PA to the entry to which the ALL0 flag is set in the L2P table. By managing all “0” in the L2P table 31, the memory area set to all “0”can be released.

Furthermore, with the configuration according to the present embodiment, in a case where the data determination unit 121 determines all “0”, the write control unit 102 can discard the corresponding write-back data without executing the write-back operation in the nonvolatile memory 20. Therefore, an increase in the write amplification factor (WAF) in the nonvolatile memory 20 can be suppressed. Furthermore, since the write-back operation can be omitted, the processing time of the write operation can be shortened. As a result, the processing capability of the memory system 3 can be improved.

In addition, with the configuration according to the present embodiment, writing of valid data of all “0” to the nonvolatile memory 20 can be omitted. As a result, copying of all “0” can be omitted at the time of garbage collection, whereby overhead of the garbage collection can be suppressed.

Furthermore, with the configuration according to the present embodiment, in a case where the ALL0 flag of the target entry of the L2P table is set up in the refill operation, the read control unit 103 can generate all “0” data and refill the cache 101 with the generated data. Thus, the read operation in the nonvolatile memory 20 can be omitted. Therefore, the latency of the refill operation can be reduced.

In the present embodiment, the case where the host 2 generates SEG data of all “0” when releasing the memory area has been described, but the data is not limited to have all “0”. For example, the host 2 may generate a preset data pattern other than all “0”. The data determination unit 121 of the memory system 3 may determine whether or not the received data matches the preset data pattern, and set a flag and discard the write-back data in a case where the received data matches the data pattern.

### 2. Second Embodiment

Next, a second embodiment will be described. The second embodiment will describe a case where a host 2 transmits a trim request to a memory system 3. The differences from the first embodiment will be mainly described below.

### 2.1 Functional Configuration of Memory System

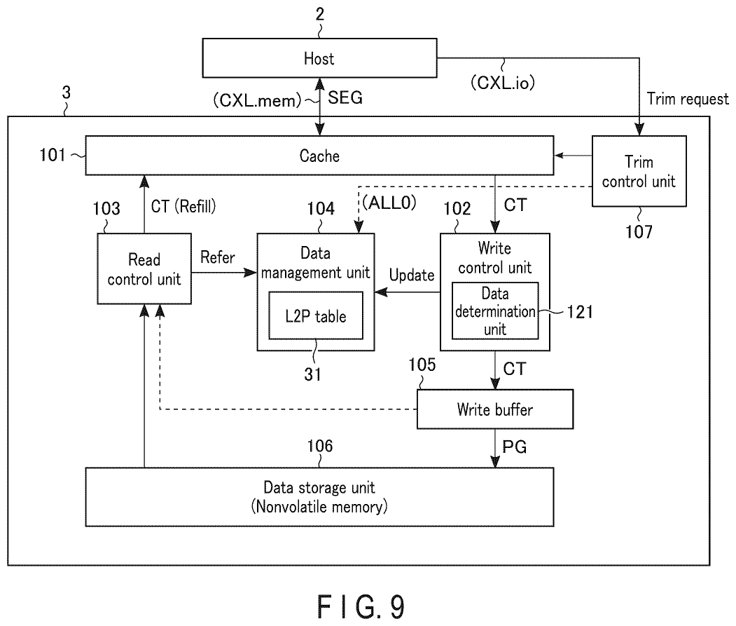

First, an example of the functional configuration of the memory system 3 will be described with reference to FIG. 9. FIG. 9 is a block diagram illustrating an example of a functional configuration of the memory system 3 focusing on a flow of data.

As illustrated in FIG. 9, the memory system 3 includes a cache 101, a write control unit 102, a read control unit 103, a data management unit 104, a write buffer 105, a data storage unit 106, and a trim control unit (circuit) 107 as functional configurations. For example, the functions of the write control unit 102, the read control unit 103, the data management unit 104, and the trim control unit 107 are implemented by a control circuit 11. The cache 101, the write control unit 102, the read control unit 103, the data management unit 104, the write buffer 105, and the data storage unit 106 are similar to those described in the first embodiment with reference to FIG. 4.

In the present embodiment, in a case where a host CPU 4 of the host 2 releases a certain memory space in the memory system 3 by, for example, calling free( ), the host CPU 4 transmits a trim request to the trim control unit 107 based on a CXL.io protocol. The trim request includes information regarding a trim command, a start logical address LA, and a data size. The trim command in the present embodiment is a command requesting writing of all “0”. The unit of the data size in the trim request is the same data unit as the segment SEG. The data size in the trim request may be a size corresponding to a plurality of segments SEG. Therefore, the trim request can collectively request writing of all “0” to the memory space (for example, the plurality of segments SEG) corresponding to the plurality of consecutive logical addresses LA. The host CPU 4 can omit transmission of data of all “0” through CXL.mem by transmitting the trim request. In other words, the trim request in the present embodiment is an alternative write request of all “0”.

The trim control unit 107 is a circuit that is configured to control trim processing in the memory system 3. The trim processing in the present embodiment is processing of setting the data in the memory area designated by the trim request to all “0”. A plurality of consecutive logical addresses LA corresponding to the data size from the start logical address LA of the trim request corresponds to the address range of the trim processing. The trim control unit 107 determines the address range of the trim processing from the start logical address LA of the trim request and the data size.

For example, there is a case where the address range of the trim processing and the address range of the entry of an L2P table 31 are not aligned. Specifically, for example, an address range of one entry of the L2P table 31 corresponds to four logical addresses LA (four pieces of SEG data). On the other hand, for example, the number of logical addresses LA included in the address range of the trim processing may not be 4j (j is any natural number). In addition, there is, for example, a case where, even if the number of logical addresses LA included in the address range of the trim processing is 4j, the start logical address LA of the trim processing is not aligned on the head logical address LA of the entry. In such a case, in the L2P table 31, there is an entry in which at least one of the corresponding logical addresses LA is not included in the address range of the trim processing.

For example, in a case where there is an entry in the L2P table 31 in which at least one of the corresponding logical addresses LA is not included in the address range of the trim processing, the trim control unit 107 generates all “0” corresponding to the logical address(es) LA of the entry in the address range of the trim processing. In other words, in a case where there is a cluster CT in which at least one of segments SEG is not included as targets for trim processing, the trim control unit 107 generates all “0” corresponding to the segments SEG in the address range of the trim processing in the cluster CT. The trim control unit 107 transmits all “0” to the cache 101. The cache 101 handles data received from the trim control unit 107 in a manner similar to data of the write request. That is, the read-modify-write operation is executed.

In a case where, for example, there is an entry in the L2P table 31 in which all logical addresses LA are included in the address range of the trim processing, the trim control unit 107 gives a notification indicating that the entry is all “0” to the data management unit 104 without generating CT data of all “0” corresponding to the entry. The data management unit 104 sets the ALL0 flag of the corresponding entry in the L2P table to “1” as with the determination result by the data determination unit 121. Such processing is hereinafter also referred to as “ALL0 processing”.

### 2.2 Overall Flow of Trim Request

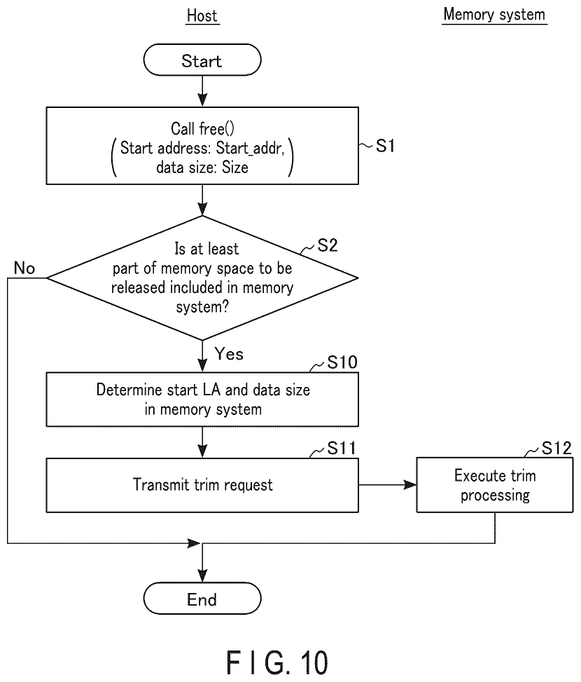

Next, an example of an overall flow in a case where a trim request is issued from the host 2 to the memory system 3 will be described with reference to FIG. 10. FIG. 10 is a flowchart illustrating an example of an overall flow in a case where a trim request is issued from the host 2 to the memory system 3. The example illustrated in FIG. 10 illustrates a case where the host CPU 4 of the host 2 issues a trim request based on free( ). Note that the trim request is not limited to calling free( ). In a case where the write data is all “0”, the host 2 may transmit the trim request instead of the write request.

As illustrated in FIG. 10, the host 2 calls free( ) (S1) as in the first embodiment described with reference to FIG. 6.

When calling free( ), the host CPU 4 checks whether or not at least a part of the memory space to be released is included in the memory system 3 as in the first embodiment described with reference to FIG. 6. In a case where at least a part of the memory space to be released is not included in the memory system 3 (S2_No), the host CPU 4 does not issue a trim request to the memory system 3.

In a case where at least a part of the memory space to be released is included in the memory system 3 (S2_Yes), the host CPU 4 determines a pair of a start logical address LA and a data size corresponding to the released memory space in the memory system 3 (S10). A plurality of pairs of the start logical address LA and the data size may be determined corresponding to the released memory space in the memory system 3.

The host CPU 4 transmits a trim request to the memory system 3 so that the memory system 3 performs trim processing on the segments SEG in a number corresponding to the data size from the start logical address LA (S11). For example, in a case where there are multiple pairs of the start logical address LA and the data size, the host CPU 4 may transmit a plurality of trim requests respectively corresponding to the pairs, or may prepare a command that can specify a plurality of pairs of the start logical address LA and the data size in a single trim request.

The memory system 3 executes the trim processing based on the received trim request (S12). When completing the trim processing, the memory system 3 transmits a command response to the host 2.

Note that the host CPU 4 may not transmit the trim request to the memory system 3 immediately after calling free( ). For example, when currently executing another processing, the host CPU 4 may transmit the trim request after completing the other processing. Similarly, when receiving a trim request while currently executing another processing, the memory system 3 may execute the trim processing after completing the other processing.

In addition, the host CPU 4 may collectively transmit a plurality of trim requests to the memory system 3 after some memory spaces to be released are accumulated by a plurality of calls of free( ).

### 2.3 Flow of Trim Processing in Memory System

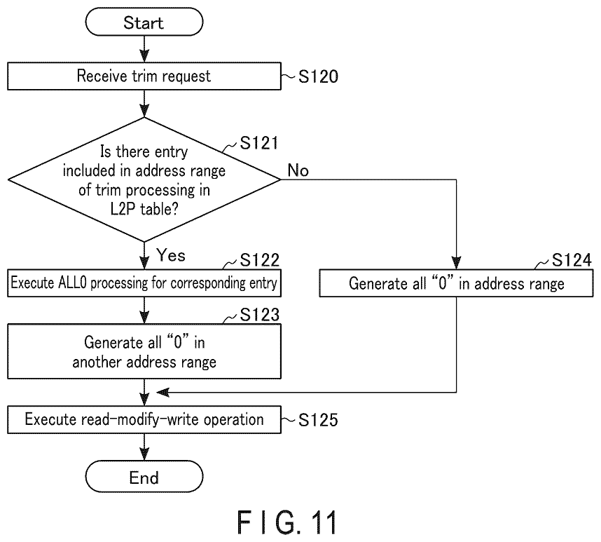

Next, an example of a flow of the trim processing in the memory system 3 will be described with reference to FIG. 11. FIG. 11 is a flowchart illustrating an example of a flow of the trim processing in the memory system 3.

As illustrated in FIG. 11, the trim control unit 107 of the memory system 3 receives a trim request from the host 2 (S120).

The trim control unit 107 checks whether or not there is an entry included in the address range of the trim processing in the L2P table 31. More specifically, the trim control unit 107 determines the address range of the logical address LA to be subjected to the trim processing from the start logical address LA and the data size of the trim request. The trim control unit 107 checks whether or not there is an entry in which all of the corresponding logical addresses LA are included in the address range of the trim processing by referring to the L2P table 31.

In a case where there is an entry in which all of the corresponding logical addresses LA are included in the address range of the trim processing in the L2P table 31 (S121_Yes), the trim control unit 107 causes the data management unit 104 to execute the ALL0 processing on the corresponding entry (S122). More specifically, the data management unit 104 sets the ALL0 flag of the entry in which all of the corresponding logical addresses LA are included in the address range of the trim processing to “1” in the L2P table 31.

The trim control unit 107 generates all “0” corresponding to an address range for which the ALL0 processing has not been executed in the address range of the trim processing (S123). More specifically, the trim control unit 107 generates all “0” corresponding to the logical address LA excluding the logical address LA corresponding to the entry for which the ALL0 processing has been executed in the address range of the trim processing. The trim control unit 107 transmits the generated data of all “0”to the cache 101.

In a case where there is no entry in which all of the corresponding logical addresses LA are included in the address range of the trim processing in the L2P table 31 (S121_No), the trim control unit 107 generates all “0” corresponding to the address range of the trim processing (S124). The trim control unit 107 transmits the generated data of all “0”to the cache 101.

When the cache 101 receives the data of all “0” from the trim control unit 107, the read-modify-write operation is executed (S125). The read-modify-write operation is similar to that described in the first embodiment with reference to FIG. 7.

### 2.4 Effects According to Present Embodiment

With the configuration according to the present embodiment, the same effects as those of the first embodiment can be obtained.

In addition, with the configuration according to the present embodiment, when releasing the memory area of the memory system 3, the host 2 can transmit a trim request to the memory system 3. The memory system 3 includes a trim control unit 107. The trim control unit 107 can release the memory area with finer granularity than the unit of management of data by setting the address range of the trim processing to all “0” based on the trim request.

Furthermore, with the configuration according to the present embodiment, the host 2 can transmit the trim request to the memory system 3 based on the CXL.io protocol. The transmission of write data of all “0” from the host 2 to the memory system can be omitted. Thus, the use of the bandwidth corresponding to the CXL.mem protocol can be reduced.

Furthermore, with the configuration according to the present embodiment, the start logical address LA and the data size are designated in the trim request, whereby it is possible to instruct release of a memory area wider than the memory area corresponding to one segment SEG by a single trim request. As a result, the host CPU 4 does not need to issue the trim request (or issue write data request of all “0” data) for each segment SEG, and thus, it is possible to reduce the overhead for the request issuance of the host CPU4.

In addition, with the configuration according to the present embodiment, the trim control unit 107 can execute the ALL0 processing in a case where there is an entry included in the address range of the trim processing in the L2P table 31. Thus, the amount of data of all “0” transmitted from the trim control unit 107 to the cache 101 can be reduced. Therefore, the contamination of (an increase in dirty data in) the cache 101 can be suppressed.

In the present embodiment, the case where the trim control unit 107 sets the address range (memory area) of the trim processing to all “0” based on the trim request has been described, but the data pattern is not limited to all “0” as in the first embodiment. The trim control unit 107 may generate, for example, a preset data pattern other than all “0”.

### 2.5 Modification of Second Embodiment

Next, a modification of the second embodiment will be described. The present modification will describe a case where data of all “0” is generated even in a case where there is an entry in which all of the corresponding logical addresses LA are included in the address range of the trim processing in the L2P table 31. The differences from the second embodiment will be mainly described below.

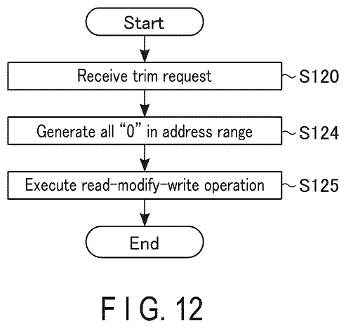

An example of a flow of the trim processing in the memory system 3 will be described with reference to FIG. 12. FIG. 12 is a flowchart illustrating an example of a flow of the trim processing in the memory system 3.

As illustrated in FIG. 12, the trim control unit 107 of the memory system 3 receives a trim request from the host 2 (S120).

The trim control unit 107 generates all “0” corresponding to an address range of the trim processing (S124). The trim control unit 107 transmits the generated data of all “0” to the cache 101.

When the cache 101 receives the data of all “0” from the trim control unit 107, the read-modify-write operation is executed (S125). The read-modify-write operation is similar to that described in the first embodiment with reference to FIG. 7.

### 2.6 Effects According to Modification of Second Embodiment

With the configuration according to the present modification, the same effects as those of the first embodiment can be obtained.

Further, with the configuration according to the present modification, the trim control unit 107 can release the memory area with finer granularity than the unit of management of data by setting the address range of the trim processing to all “0” based on the trim request, as in the second embodiment.

In addition, the configuration according to the present modification can reduce the use of the bandwidth corresponding to the CXL.mem protocol, as in the second embodiment.

Further, with the configuration according to the present modification, the host CPU 4 does not need to issue the trim request (or issue write data request of all “0” data) for each segment SEG, and thus, it is possible to reduce the overhead for the request issuance of the host CPU 4, as in the second embodiment.

In the present modification, the case where the trim control unit 107 sets the address range of the trim processing to all “0” based on the trim request has been described, but the data pattern is not limited to all “0” as in the second embodiment. The trim control unit 107 may generate, for example, a preset data pattern other than all “0”.

### 3. Third Embodiment

Next, a third embodiment will be described. The third embodiment will describe a case where a data determination unit 121 of a memory system 3 detects a preset data pattern (hereinafter, referred to as a “fixed value”).

The data determination unit 121 in the present embodiment determines whether or not write-back data received by a write control unit 102 has a fixed value. An L2P table 31 has a flag corresponding to the fixed value. Similarly to all “0” in the first embodiment, the memory system 3 manages the fixed value in the L2P table and does not execute a write-back operation to a data storage unit 106. The fixed value may be all “0”, all “1”, or any data pattern such as “0101 . . . ”. The differences from the first and second embodiments will be mainly described below.

In the present embodiment, a host 2 may transmit a write request for writing a fixed value, for example, in response to free( ).

### 3.1 L2P Table

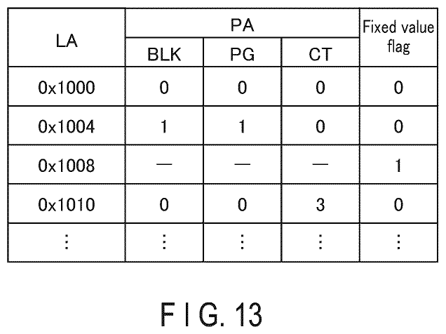

First, an example of the L2P table 31 will be described with reference to FIG. 13. FIG. 13 is a diagram illustrating a specific example of the L2P table 31.

As illustrated in FIG. 13, the L2P table 31 includes information regarding a logical address LA, information regarding a physical address PA, and information regarding a fixed value flag for each entry. A plurality of fixed value flags may be set.

The fixed value flag is information indicating whether or not the data in the cluster CT has a fixed value. For example, in a case where CT data does not have the fixed value, the fixed value flag is set to “0”. On the other hand, in a case where CT data has the fixed value, the fixed value flag is set to “1” (the fixed value flag is set up). In a case where the fixed value flag is “1”, the physical address PA corresponding to the logical address LA may not be assigned. That is, in a case where the fixed value flag is set up, the write-back operation to the nonvolatile memory 20 is unnecessary. Note that the fixed value may be written in the nonvolatile memory 20. When receiving the read request, the memory controller 10 checks the L2P table 31. In a case where the fixed value flag is “1”, the memory controller 10 finds that the corresponding CT data has the fixed value. In this case, the memory controller 10 can omit the read operation in the nonvolatile memory 20.

For example, in a case where the fixed value flag is changed from “0” to “1” by data rewriting, the physical address PA corresponding to the logical address LA, that is, the memory area of the nonvolatile memory 20, is in a released state. That is, the data in the memory area is regarded as invalid data.

In the example illustrated in FIG. 13, the cluster CT0 of the page PG0 of a block BLK0 is assigned to “0x1000” of the logical address LA, and the fixed value flag is set to “0”. The cluster CT0 of the page PG1 of a block BLK1 is assigned to “0x1004” of the logical address LA, and the fixed value flag is set to “0”. The fixed value flag corresponding to “0x1008” of the logical address LA is set to “1”, and the physical address PA is not assigned. The cluster CT3 of the page PG0 of a block BLK0 is assigned to “0x1010” of the logical address LA, and the fixed value flag is set to “0”.

### 3.2 Read-Modify-Write Operation in Memory System

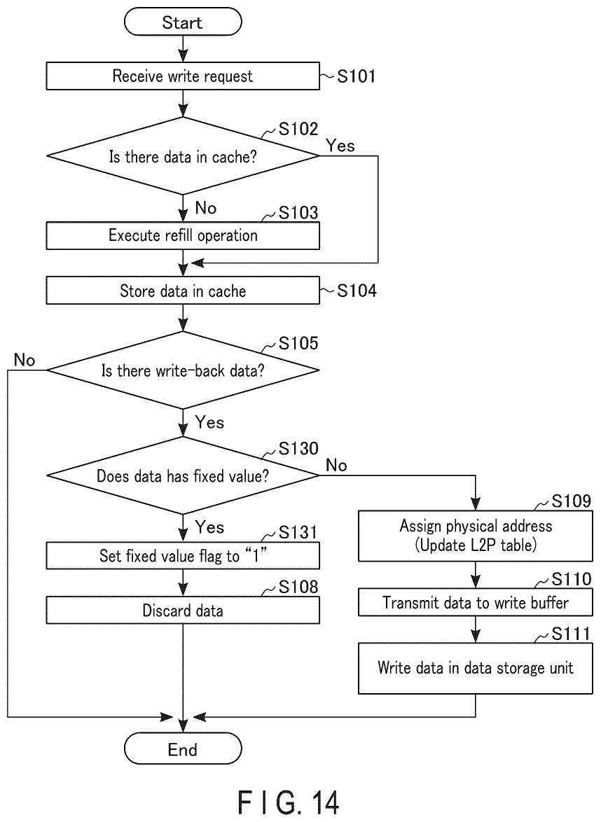

Next, an example of a flow of the read-modify-write operation in the memory system 3 will be described with reference to FIG. 14. FIG. 14 is a flowchart illustrating an example of a flow of the read-modify-write operation in the memory system 3. The following description will focus on a case where the write-back data, which were received from the host 2 as SEG data, has a fixed value.

As illustrated in FIG. 14, the operations in steps S101 to S105 are similar to those in the first embodiment described with reference to FIG. 7.

In a case where there is write-back data (S105_Yes), the data determination unit 121 of the write control unit 102 checks whether or not the write-back data has a fixed value.

In a case where the write-back data has the fixed value (S130_Yes), the data management unit 104 sets the fixed value flag of the corresponding entry of the L2P table 31 to “1” (S131). Then, the write control unit 102 discards the write-back data without executing the write-back operation (S108). For example, in a case where the fixed value flag is changed from “0” to “1”, the memory area of the physical address PA associated with the logical address LA of the corresponding entry is released. In other words, in the data storage unit 106, data stored in the memory area corresponding to the physical address PA is set as invalid data.

In a case where the write-back data does not have the fixed value (S130_No), the data management unit 104 sets the fixed value flag of the corresponding entry of the L2P table 31 to “0” and assigns one of the physical addresses PA (S109). That is, the L2P table is updated. Then, the write control unit 102 transmits the write-back data to the write buffer 105 (S110).

When the amount of data stored in the write buffer 105 reaches the amount of data to be used for the write-back operation, PG data is transmitted from the write buffer 105 to the data storage unit 106, and the write-back operation is executed in the data storage unit 106 (S111).

### 3.3 Refill Operation

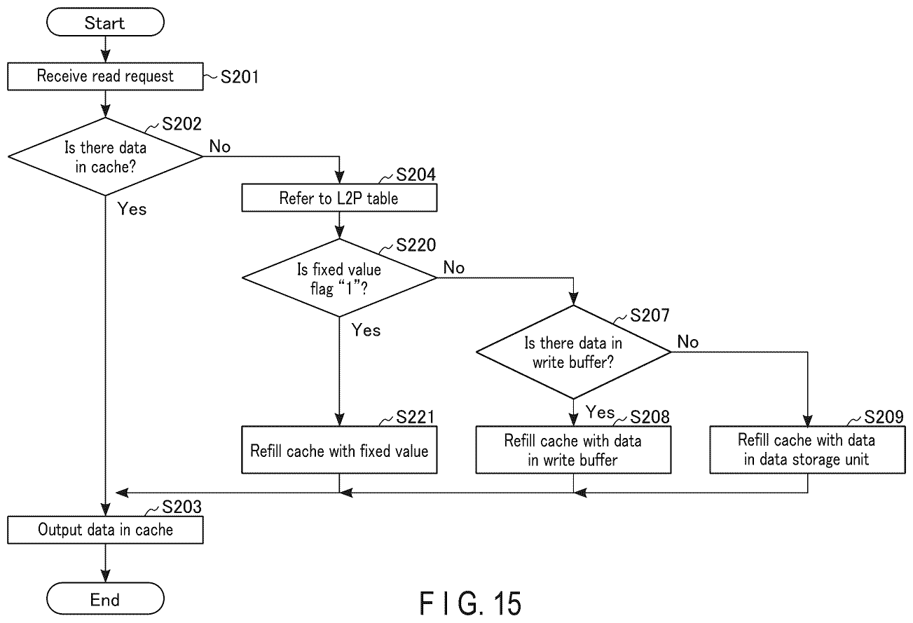

Next, an example of a flow of the refill operation will be described with reference to FIG. 15. FIG. 15 is a flowchart illustrating an example of a flow of the refill operation. FIG. 15 illustrates a case where the refill operation is executed based on the read request. Note that the same applies to the refill operation in the read-modify-write operation.

As illustrated in FIG. 15, the operations in steps S201 and S202 are similar to those in the first embodiment described with reference to FIG. 8.

In a case where there is no corresponding data in the cache 101 (S202_No), the read control unit 103 refers to the L2P table 31 (S204).

In a case where the fixed value flag of the entry corresponding to the address range including the logical address LA of the read request is “1” (S220_Yes), the read control unit 103 generates refill data having the fixed value and refills the cache 101 with the refill data (S221).

In a case where the fixed value flag of the entry corresponding to the address range including the logical address LA of the read request is “0” (S220_No), the read control unit 103 checks whether or not data corresponding to the logical address LA of the read request is included in the write buffer 105.

The operations in steps S207 to S209 are similar to those in the first embodiment described with reference to FIG. 8.

In a case where there is the corresponding data in the cache 101 (S202_Yes), or after the cache 101 is refilled with the data by any of steps S221, S208, and S209, the read control unit 103 outputs SEG data corresponding to the logical address LA of the read request in the cache 101 to the host (S203).

### 3.4 Effects According to Present Embodiment

With the configuration according to the present embodiment, the same effects as those of the first embodiment can be obtained.

Furthermore, the configuration according to the present embodiment makes it possible to support data patterns other than all “0”.

### 4. Fourth Embodiment

Next, a fourth embodiment will be described. The fourth embodiment will describe a case where data is encrypted when the data is transmitted from a host 2 to a memory system 3. Note that the data may be encrypted when the data is transmitted from the memory system 3 to the host 2. The differences from the first to third embodiments will be mainly described below.

### 4.1 Functional Configuration of Host and Memory System

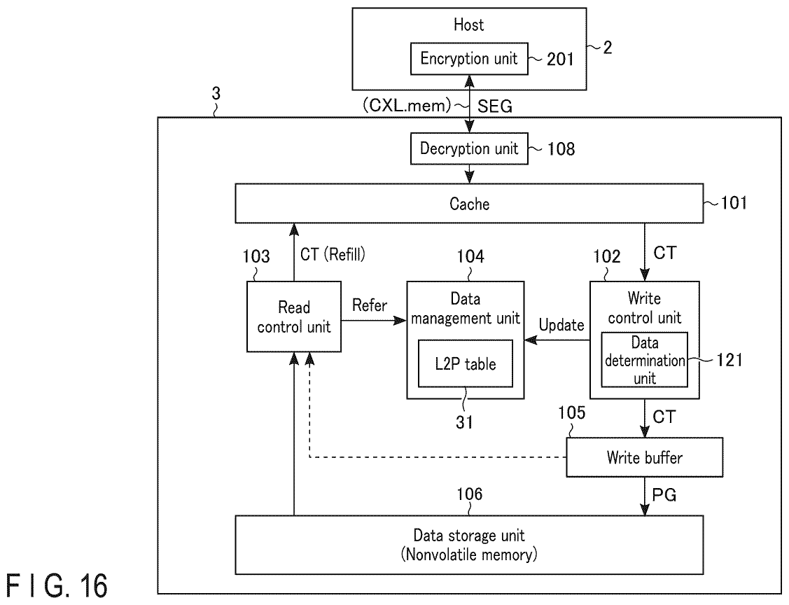

First, an example of the functional configurations of the host 2 and the memory system 3 will be described with reference to FIG. 16. FIG. 16 is a block diagram illustrating an example of functional configurations of the host 2 and the memory system 3 focusing on a flow of data.

As illustrated in FIG. 16, the host 2 includes an encryption unit 201 as a functional configuration. For example, the function of the encryption unit 201 is implemented by a host CPU 4.

When transmitting data from the host 2 to the memory system 3, the encryption unit 201 encrypts the data.

The memory system 3 includes a cache 101, a write control unit 102, a read control unit 103, a data management unit 104, a write buffer 105, a data storage unit 106, and a decryption unit (circuit) 108 as functional configurations. For example, the functions of the write control unit 102, the read control unit 103, the data management unit 104, and the decryption unit 108 are implemented by a control circuit 11. The cache 101, the write control unit 102, the read control unit 103, the data management unit 104, the write buffer 105, and the data storage unit 106 are similar to those described in the first embodiment with reference to FIG. 4.

The decryption unit 108 is a circuit that is configured to decrypt input data received from the host 2. The decrypted data is transmitted to the cache 101.

### 4.2 Effects According to Present Embodiment

The configuration according to the present embodiment can be applied to the first to third embodiments. Thus, the same effects as those of the first to third embodiments can be obtained.

Furthermore, with the configuration according to the present embodiment, data can be encrypted and transmitted, so that confidentiality can be improved.

### 5. Modifications, etc.

The memory system (3) according to the above embodiments includes a data management circuit (104), a memory (106) configured to store data, a write control circuit (102) configured to control writing of data to the memory, and a data determination circuit(121). The data management circuit is configured to manage data, which is received from a host (2) on a first data size (SEG) basis, on a second data size (CT) basis using a management table (31). The second data size is greater than the first data size. The data determination circuit is configured to determine whether or not data of the second data size received by the write control circuit matches a data pattern set in advance. In a case where first data of the second data size received by the write control circuit matches the data pattern, the data management circuit is further configured to set a flag indicating that the first data matches the data pattern in an entry of the management table corresponding to the first data, and the write control circuit is further configured to discard the first data without writing the first data to the memory.

With the configuration according to the above-mentioned embodiments, a memory system capable of releasing a memory area not limited to a unit of management of data of the memory system can be provided.

Note that the present invention is not limited to the above-described embodiments, and various modifications can be applied.

For example, in the above embodiments, a direct memory access controller (DMAC) may be used for data transfer between the host 2 and the memory system 3. In this case, instead of the host CPU 4, the DMAC may transfer data having a fixed value such as all “0”.

In the above embodiments, the host CPU 4 may transfer processing such as issuance of a write request or a trim request to the memory system 3 to a processor that assists the host CPU 4 such as a data processing unit (DPU).

Furthermore, the term “couple” in the above embodiments also includes a state in which components are indirectly coupled to each other with something such as a transistor or a resistor interposed therebetween.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a data management circuit configured to manage data, which is received from a host on a first data size basis, on a second data size basis using a management table, the second data size being greater than the first data size;
a memory configured to store data;
a write control circuit configured to control writing of data to the memory; and
a data determination circuit configured to determine whether or not data of the second data size received by the write control circuit matches a data pattern set in advance, wherein,
in a case where first data of the second data size received by the write control circuit matches the data pattern,
the data management circuit is further configured to set a flag indicating that the first data matches the data pattern in an entry of the management table corresponding to the first data, and
the write control circuit is further configured to discard the first data without writing the first data to the memory.

2. The memory system according to claim 1, wherein,
in a case where the first data does not match the data pattern,
the data management circuit is further configured to assign a physical address of the memory to the entry of the management table corresponding to the first data, and
the write control circuit is further configured to write the first data in a memory area corresponding to the physical address of the memory.

3. The memory system according to claim 1, further comprising:
a cache configured to store data; and
a read control circuit configured to control reading of data from the memory, wherein,
in an operation based on a write request received from a host,
the read control circuit is further configured to fill the cache with second data of the second data size corresponding to a logical address range including a first logical address of the write request, and
a part of the second data is replaced with third data of the first data size included in the write request in the cache.

4. The memory system according to claim 3, wherein
the read control circuit is further configured to transmit the data pattern generated as the second data to the cache, in a case where the flag is set in the entry of the management table corresponding to the logical address range including the first logical address.

5. The memory system according to claim 3, wherein
the read control circuit is further configured to transmit the second data read from the memory to the cache, in a case where the flag is not set in the entry of the management table corresponding to the logical address range including the first logical address.

6. The memory system according to claim 1, wherein
the data pattern is all “0”.

7. The memory system according to claim 1, wherein,
in an entry of the management table in which the flag is set, a physical address of the memory corresponding to the logical address is not assigned.

8. The memory system according to claim 1, further comprising
a trim control circuit configured to receive a first command giving an instruction on writing of the data pattern, wherein
the trim control circuit is further configured to generate data corresponding to the data pattern, in a case where the trim control circuit receives the first command.

9. The memory system according to claim 8, wherein
the trim control circuit is further configured to, in a case where an address range corresponding the first command covers all of logical addresses of an entry of the management table, instruct the data management circuit to set the flag on the entry without generating data corresponding to the entry.

10. The memory system according to claim 1, further comprising
a decryption circuit configured to decrypt input data that has been encrypted.

11. The memory system according to claim 1, wherein
the memory is a NAND flash memory.

12. An information processing system comprising:
the memory system according to claims 1; and
a host configured to control the memory system, wherein
the host is further configured to transmit the write request of the data pattern to the memory system, in a case where the host releases a memory area of the memory system.

13. An information processing system comprising:
the memory system according to claim 8; and
a host configured to control the memory system, wherein
the host is further configured to transmit the first command to the memory system, in a case where the host releases a memory area of the memory system.

14. A memory system control method for managing data, which has been received from a host on a first data size basis, on a second data size basis using a management table, the second data size being greater than the first data size, the memory system control method comprising:
determining whether or not first data of the second data size to be written matches a data pattern set in advance;
in a case where the first data matches the data pattern
setting a flag indicating that the first data matches the data pattern in an entry of the management table corresponding to the first data; and
discarding the first data without writing the first data to a memory.

15. The memory system control method according to claim 14, further comprising:
in a case where the first data does not match the data pattern in the operation based on the write request,
assigning a physical address of the memory to the entry of the management table corresponding to the first data; and
writing the first data in a storage area corresponding to the physical address of the memory.

16. The memory system control method according to claim 14, further comprising:
in the operation based on the write request,
filling a cache with second data of the second data size corresponding to a logical address range including a first logical address of the write request; and
replacing a part of the second data with third data of the first data size corresponding to the write request in the cache.

17. The memory system control method according to claim 16, further comprising,
in a case where the flag is set in the entry of the management table corresponding to the logical address range including the first logical address, transmitting the data pattern generated as the second data to the cache.

18. The memory system control method according to claim 16, further comprising,
in a case where the flag is not set in the entry of the management table corresponding to the logical address range including the first logical address, transmitting the second data read from the memory to the cache.

19. The memory system control method according to claim 14, wherein
the data pattern is all “0”.

20. A memory system comprising:
a nonvolatile memory connectable to a host and configured to store data; and
a memory controller configured to
control the nonvolatile memory,
transmit and receive data to and from the host on a first data size basis,
manage data on a second data size basis using a management table, the second data size being greater than the first data size, and
determine whether or not data of the second data size matches a data pattern set in advance, wherein,
in a case where first data of the second data size included in data based on a write request received from the host has the data pattern,
the memory controller is configured to set a flag indicating that the first data matches the data pattern in an entry of the management table corresponding to the first data, and discard the first data without writing the first data to the nonvolatile memory.
